(19) United States
(12) Patent Application Publication
(10) Pub. No.: US 2025/0288019 A1
(43) Pub. Date: Sep. 18, 2025

(54) Aerosol Generation Device

(71) Applicant: JT International SA, Geneva (CH)

(72) Inventors: Alec Wright, Guildford (GB); Grzegorz Alexander Pilatowicz, Grens (CH)

(73) Assignee: JT International SA, Geneva (CH)

(21) Appl. No.: 18/862,732

(22) PCT Filed: May 9, 2023
(86) PCT No.: PCT/EP2023/062270

§ 371 Date: Nov. 4, 2024

(30) Foreign Application Priority Data
May 9, 2022 (EP) 22172343.0

(51) Int. Cl. A24F 40/57; A24F 40/40; A24F 40/95; H05B 6/10

(52) U.S. Cl. CPC A24F 40/57; A24F 40/40; A24F 40/95; H05B 6/108

(57) ABSTRACT

An aerosol generation device includes a holding unit configured to receive and aerosolise an aerosol generating substrate, and a charging unit that is connectable to the holding unit. The holding unit includes a heater component and a first charge storage module to power the heater component. The charging unit includes a second charge storage module to power the heater component when the charging unit is connected to the holding unit. A controller is configured to pre-heat the heater component by directing a first power flow from the first charge storage module in a first pre-heating manner when the holding unit is not connected to the charging unit, and pre-heat the heater component by directing a second power flow from the second charge storage module in a second pre-heating manner when the holding unit is connected to the charging unit.

### FIELD OF INVENTION

The present invention relates to aerosol generation devices, and more specifically aerosol generation device power systems.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Problems faced by known aerosol generation devices include providing effective power management, as well as improving usability.

### SUMMARY OF INVENTION

An object of the invention is to address providing effective power management, and improving usability, amongst others.

In a first aspect, there is provided an aerosol generation device comprising a holding unit configured to receive and aerosolise an aerosol generating substrate, and a charging unit that is connectable to the holding unit;
the holding unit comprising a heater component configured to aerosolise the aerosol generating substrate, and a first charge storage module configured to power the heater component;
the charging unit comprising a second charge storage module configured to power the heater component when the charging unit is connected to the holding unit;
the aerosol generation device further comprising a controller configured to:
when the holding unit is not connected to the charging unit, pre-heat the heater component to a predetermined temperature for an aerosolisation session by directing a first power flow from the first charge storage module to the heater component in a first pre-heating manner; and
when the holding unit is connected to the charging unit, pre-heat the heater component to the predetermined temperature for an aerosolisation session by directing a second power flow from the second charge storage module to the heater component in a second pre-heating manner.

In this way, the operator of the aerosol generation device is given power management flexibility as to whether to power the pre-heating phase with the first charge storage module in the holding unit, with the holding unit disconnected from the chagrining unit, or the second charge storage module in the charging unit, with the holding unit connected to the charging unit.

Preferably, the first pre-heating manner comprises directing the first power flow from the first charge storage module to the heater component for a first predetermined period of time; and
wherein the second pre-heating manner comprises directing the second power flow from the second charge storage module to the heater component for a second predetermined period of time.

Preferably, the first predetermined period of time is longer than the second predetermined period of time, and the first power flow is a lower power than second power flow.

In this way, the operator of the aerosol generation device is given power management flexibility as to whether to power the pre-heating phase more slowly with only the first charge storage module and the holding unit disconnected from the charging unit, or more rapidly using the second charge storage module in the charging unit with the holding unit connected to the charging unit.

Preferably, the controller is configured to:
when the holding unit is connected to the charging unit, direct a power flow from the second charge storage module to the heater component to maintain the predetermined temperature in a heating phase of the aerosolisation session after the heater component is pre-heated; and
when the holding unit is not connected to the charging unit, direct a power flow from the first charge storage module to the heater component to maintain the predetermined temperature in the heating phase of the aerosolisation session after the heater component is pre-heated.

In this way, the operator of the aerosol generation device is given power management flexibility as to whether to power the heating phase with the first charge storage module in the holding unit, with the holding unit disconnected from the chagrining unit, or the second charge storage module in the charging unit, with the holding unit connected to the charging unit.

Preferably, the controller is further configured to:
when the holding unit is connected to the charging unit, direct a power flow from the second charge storage module to the first charge storage module to charge the first charge storage module.

In this way, the second charge storage module in the charging unit is used to recharge the first charge storage module in the holding unit to help ensure that the first charge storage module has an adequate charge level for when the holding unit is disconnected from the charging unit. This improves the overall power management.

Preferably, the holding unit is configured to be received within the charging unit when connected to charging unit.

Preferably, the holding unit comprises a cavity into which the aerosol generating substrate is insertable for heating with the heater component to generate an aerosol.

Preferably, the holding unit comprises a cavity into which the aerosol generating substrate is insertable for heating with the heater component to generate an aerosol, wherein the cavity is accessible to receive the aerosol generating substrate when the holding unit is received within the charging unit.

In this way, the operator can perform an aerosolisation when the holding unit is connected to the charging unit.

Preferably, the cavity is configured to receive an aerosol generating substrate that is substantially planar in shape. Preferably, the cavity that is configured to receive an aerosol generating substrate that is substantially planar in shape comprises two major internal faces, wherein the two major internal faces oppose one another, the aerosol generating substrate is configured to be received between the opposing major internal faces, and the major internal faces are each associated with a heating element of the heater component. Preferably, the major internal faces comprise a ceramic material and the heating elements are arranged on or embedded in the ceramic material.

Alternatively, the cavity is configured to receive an aerosol generating substrate that is rod shaped. Preferably, the aerosol generating substrate is a tobacco rod.

Preferably, the second charge storage module has a greater charge storage capacity than the first charge storage module.

In this way, a physically smaller charge storage module can be included in the holding unit, for improved comfort and safety.

Preferably, the first charge storage module can be one or more batteries, supercapacitors, or a combination thereof. Preferably, the second charge storage module can be one or more batteries, supercapacitors, or a combination thereof.

Preferably, the aerosol generation device is configured to perform a first aerosolisation session followed consecutively by a second aerosolisation session, with each aerosolisation session comprising a pre-heating phase in which the heater component is pre-heated to the predetermined temperature, and a heating phase in which the heater component is maintained at the pre-determined temperature after the heater component is pre-heated.

In this way, the power in the device is managed to provide flexibility to operators in that an operator can consecutively aerosolise two substrates, or a second operator can aerosolise a second substrate using the same aerosol generation device after a first operator has aerosolised the a substrate.

Preferably, the pre-heating phase of the first aerosolisation session and the pre-heating phase of the second aerosolisation session are both performed when the holding unit is connected to the charging unit, and the controller is configured to direct the second power flow from the second charge storage module to the heater component in the second pre-heating manner for the pre-heating phase of the first aerosolisation session and the pre-heating phase of the second aerosolisation session; and
the heating phase of the first aerosolisation session and the heating phase of the second aerosolisation session are both performed when the holding unit is not connected to the charging unit, and the controller is configured to direct a power flow from the first charge storage module to the heater component for the heating phase of the first aerosolisation session and the heating phase of the second aerosolisation session.

In this way, the operator only needs to hold to more comfortable holding unit for the heating phase, whilst also benefiting from fast pre-heating if the second charge storage module is larger or more powerful.

Preferably, the pre-heating phase of the first aerosolisation session and the pre-heating phase of the second aerosolisation session are both performed when the holding unit is connected to the charging unit, and the controller is configured to direct the second power flow from the second charge storage module to the heater component in the second pre-heating manner for the pre-heating phase of the first aerosolisation session and the pre-heating phase of the second aerosolisation session;
the heating phase of the first aerosolisation session is performed when the holding unit is not connected to the charging unit, and the controller is configured to direct a power flow from the first charge storage module to the heater component for the heating phase of the first aerosolisation session; and
the heating phase of the second aerosolisation session is performed when the holding unit is connected to the charging unit, and the controller is configured to direct a power flow from the second charge storage module to the heater component for the heating phase of the second aerosolisation session.

In this way, a minimised size of charge storage module can be used in the holding unit. This is because the first charge storage module will only need to store enough charge for the heating phase of one aerosolisation sessions (e.g. the first aerosolisation session), whilst still allowing for the aerosol generation device to power consecutive aerosolisation sessions.

Preferably, the controller is configured to direct the second power flow and a power flow from the first charge storage module to the heater component for the pre-heating phase of the first aerosolisation session and the pre-heating phase of the second aerosolisation session.

In this way, the second charge storage module can be used to boost the power flow to the heater component by being combined with the power flow from the first charge storage module.

Preferably, the pre-heating phase of the first aerosolisation session is performed when the holding unit is not connected to the charging unit, and the controller is configured to direct the first power flow from the first charge storage module to the heater component in the first pre-heating manner for the pre-heating phase of the first aerosolisation session;
the heating phase of the first aerosolisation session is performed when the holding unit is not connected to the charging unit, and the controller is configured to direct a power flow from the first charge storage module to the heater component for the heating phase of the first aerosolisation session;
the pre-heating phase of the second aerosolisation session is performed when the holding unit is not connected to the charging unit, and the controller is configured to direct the first power flow from the first charge storage module to the heater component in the first pre-heating manner for the pre-heating phase of the second aerosolisation session; and
the heating phase of the second aerosolisation session is performed when the holding unit is connected to the charging unit, and the controller is configured to direct a power flow from the second charge storage module to the heater component for the heating phase of the second aerosolisation session.

In this way, the second charge storage module can power the heater component for the heating phase of the second aerosolisation session. As such, a smaller charge storage module can be used for the first charge storage module, thereby improving comfort and safety. By powering the heating phase of the second aerosolisation session using the second charge storage module, the charge level in the first charge storage module can be preserved for a subsequent aerosolisation session.

Preferably, the pre-heating phase of the first aerosolisation session is performed when the holding unit is not connected to the charging unit, and the controller is configured to direct the first power flow from the first charge storage module to the heater component in the first pre-heating manner for the pre-heating phase of the first aerosolisation session;
the heating phase of the first aerosolisation session is performed when the holding unit is not connected to the charging unit, and the controller is configured to direct a power flow from the first charge storage module to the heater component for the heating phase of the first aerosolisation session;
the pre-heating phase of the second aerosolisation session is performed when the holding unit is connected to the charging unit, and the controller is configured to direct the second power flow from the second charge storage module to the heater component in the second pre-heating manner for the pre-heating phase of the second aerosolisation session; and
the heating phase of the second aerosolisation session is performed when the holding unit is not connected to the charging unit, and the controller is configured to direct a power flow from the first charge storage module to the heater component for the heating phase of the second aerosolisation session.

In this way, the second charge storage module can power the heater component for the pre-heating phase of the second aerosolisation session. As such, a smaller charge storage module can be used for the first charge storage module, thereby improving comfort and safety. By powering the pre-heating phase of the second aerosolisation session using the second charge storage module, the charge level in the first charge storage module can be preserved for the heating phase of the second aerosolisation session.

Preferably, the pre-heating phase of the first aerosolisation session is performed when the holding unit is not connected to the charging unit, and the controller is configured to direct the first power flow from the first charge storage module to the heater component in the first pre-heating manner for the pre-heating phase of the first aerosolisation session;
the heating phase of the first aerosolisation session is performed when the holding unit is not connected to the charging unit, and the controller is configured to direct a power flow from the first charge storage module to the heater component for the heating phase of the first aerosolisation session;
the pre-heating phase of the second aerosolisation session is performed when the holding unit is connected to the charging unit, and the controller is configured to direct the second power flow from the second charge storage module to the heater component in the second pre-heating manner for the pre-heating phase of the second aerosolisation session; and
the heating phase of the second aerosolisation session is performed when the holding unit is connected to the charging unit, and the controller is configured to direct a power flow from the second charge storage module to the heater component for the heating phase of the second aerosolisation session.

In this way, the first charge storage module only needs to have the capacity to power the first aerosolisation session, meaning a smaller charge storage module can be used as a first charge storage module thereby increasing comfort and safety. This also allows for a reduced holding unit size, due to the smaller first charge storage module, whilst still allowing consecutive aerosolisation sessions to be performed.

Preferably, the pre-heating phase of the first aerosolisation session is performed when the holding unit is not connected to the charging unit, and the controller is configured to direct the first power flow from the first charge storage module to the heater component in the first pre-heating manner for the pre-heating phase of the first aerosolisation session;
the heating phase of the first aerosolisation session is performed when the holding unit is not connected to the charging unit, and the controller is configured to direct a power flow from the first charge storage module to the heater component for the heating phase of the first aerosolisation session;
the pre-heating phase of the second aerosolisation session is performed when the holding unit is not connected to the charging unit, and the controller is configured to direct the first power flow from the first charge storage module to the heater component in the first pre-heating manner for the pre-heating phase of the second aerosolisation session; and
the heating phase of the second aerosolisation session is performed when the holding unit is not connected to the charging unit, and the controller is configured to direct a power flow from the first charge storage module to the heater component for the heating phase of the second aerosolisation session.

In this way, flexibility is provided to the operator in that two aerosolisation sessions can be performed without relying on the charging unit.

Preferably, the pre-heating phase of the first aerosolisation session is performed when the holding unit is connected to the charging unit, and the controller is configured to direct the second power flow from the second charge storage module to the heater component in the second pre-heating manner for the pre-heating phase of the first aerosolisation session;
the heating phase of the first aerosolisation session is performed when the holding unit is connected to the charging unit, and the controller is configured to direct a power flow from the second charge storage module to the heater component for the heating phase of the first aerosolisation session;
the pre-heating phase of the second aerosolisation session is performed when the holding unit is connected to the charging unit, and the controller is configured to direct the second power flow from the second charge storage module to the heater component in the second pre-heating manner for the pre-heating phase of the second aerosolisation session; and
the heating phase of the second aerosolisation session is performed when the holding unit is connected to the charging unit, and the controller is configured to direct a power flow from the second charge storage module to the heater component for the heating phase of the second aerosolisation session.

In this way, stored charge in the first charge storage module can be preserved for subsequent aerosolisation sessions, thereby providing flexibility in the power management. In addition, if the second charge storage module is more powerful than the first charge storage module, faster pre-heating can be achieved.

In a second aspect, there is provided an aerosol generation system comprising the aerosol generation device of the aerosol generation device of the first aspect having an aerosol generating substrate received in the holding unit of the aerosol generation device.

In a third aspect, there is provided a method of operating an aerosol generation device, the aerosol generation device comprising:
a holding unit configured to receive and aerosolise an aerosol generating substrate and a charging unit that is connectable to the holding unit, the holding unit comprising a heater component configured to aerosolise the aerosol generating substrate, and a first charge storage module configured to power the heater component, the charging unit comprising a second charge storage module configured to power the heater component when the charging unit is connected to the holding unit;
wherein the method comprises:
when the holding unit is not connected to the charging unit, pre-heating the heater component to a predetermined temperature for an aerosolisation session by directing a first power flow from the first charge storage module to the heater component in a first pre-heating manner; and
when the holding unit is connected to the charging unit, pre-heating the heater component to a predetermined temperature for an aerosolisation session by directing a second power flow from the second charge storage module to the heater component in a second pre-heating manner.

The method of the third aspect can include the preferable features of the aerosol generation device of the first aspect, as appropriate.

In a fourth aspect, there is provided a non-transitory computer-readable medium storing instructions executable by one or more processors of an aerosol generation device, the aerosol generation device comprising:
a holding unit configured to receive and aerosolise an aerosol generating substrate and a charging unit that is connectable to the holding unit, the holding unit comprising a heater component configured to aerosolise the aerosol generating substrate, and a first charge storage module configured to power the heater component, the charging unit comprising a second charge storage module configured to power the heater component when the charging unit is connected to the holding unit,
wherein the instructions cause the one or more processors to perform steps comprising:
when the holding unit is not connected to the charging unit, pre-heating the heater component to a predetermined temperature for an aerosolisation session by directing a first power flow from the first charge storage module to the heater component in a first pre-heating manner; and
when the holding unit is connected to the charging unit, pre-heating the heater component to a predetermined temperature for an aerosolisation session by directing a second power flow from the second charge storage module to the heater component in a second pre-heating manner.

The non-transitory computer-readable medium of the fourth aspect can include the preferable features of the aerosol generation device of the first aspect, as appropriate.

### BRIEF DESCRIPTION OF THE DRAWINGS

Embodiments of the invention are now described, by way of example, with reference to the drawings, in which:

FIG. 1A is a diagram of a first exemplary aerosol generation device comprising a handpiece and a charging unit, with the handpiece removed from the charging unit;

FIG. 1B is a diagram of the first exemplary aerosol generation device comprising a handpiece and a charging unit, with the handpiece received in the charging unit;

FIG. 1C is a diagram of the first exemplary aerosol generation device comprising the handpiece and a charging unit, with the handpiece pivotally connected to the charging unit;

FIG. 2 is a diagram of the handpiece of FIGS. 1A-C in more detail;

FIG. 3 is a diagram of an aerosol generating substrate configured for use with the handpiece of FIG. 2;

FIG. 4A is a diagram of a heating chamber of the handpiece 10 of FIG. 2 with the aerosol generating substrate of FIG. 3;

FIG. 4B is a diagram of the heating chamber of FIG. 4A in more detail;

FIG. 5 is a diagram of the mouthpiece portion of the handpiece of FIG. 2 in more detail;

FIG. 6 is an exemplary plot of average power delivered to a heater against time for an aerosolisation session;

FIG. 7 is an operational flow chart of a control process for power management in an aerosolisation session;

FIG. 8A is a diagram of a second exemplary aerosol generation device comprising a handpiece and a charging unit, with the handpiece received in the charging unit; and

FIG. 8B is a diagram of the second exemplary aerosol generation device comprising a handpiece and a charging unit, with the handpiece removed from the charging unit.

### DETAILED DESCRIPTION

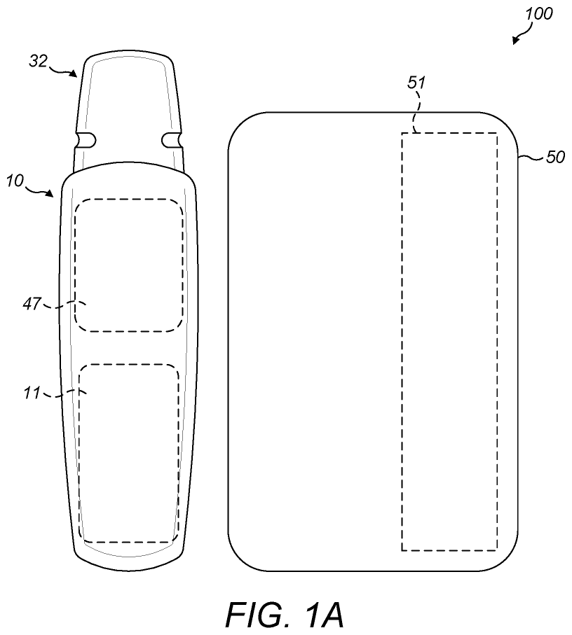

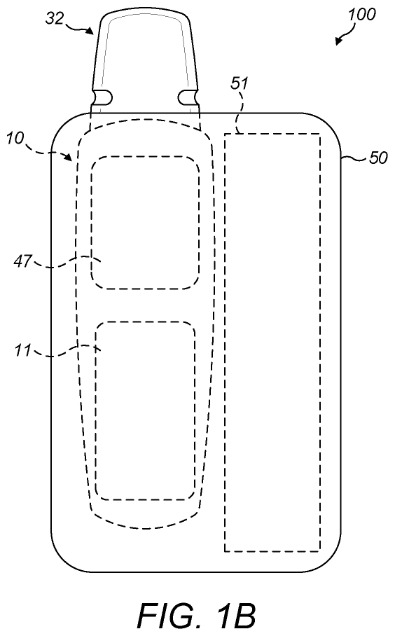

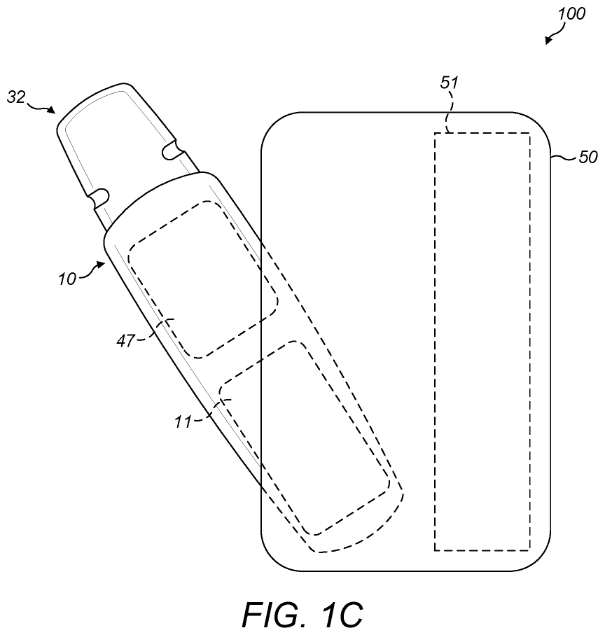

FIGS. 1A, 1B and 1C show various arrangements of a first exemplary aerosol generation device 100 (also known as a vapour generating device, vaping device, or electronic cigarette) comprising a handpiece 10 (also referred to as a holding unit) and a charging unit 50. The handpiece 10 is removably connectable to the charging unit 50.

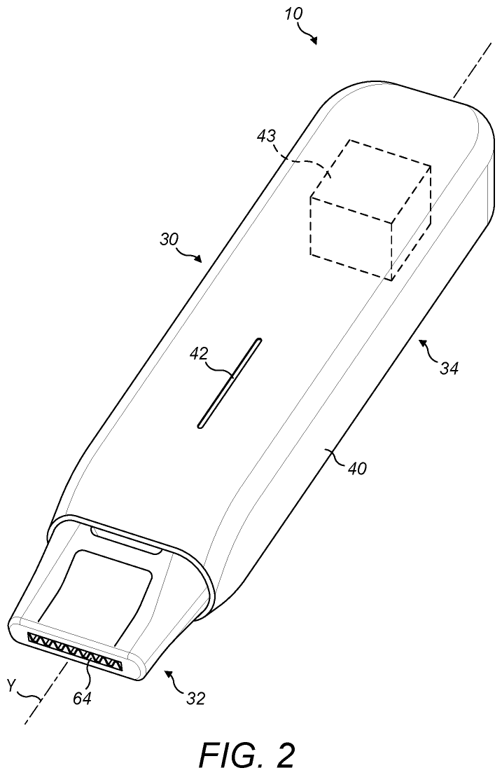

The handpiece 10 comprises a first charge storage module 11, and a heater 47 (also referred to as a heater component). The first charge storage module 11 is configured to power the heater 47 to aerosolise an aerosol generating substrate (not shown), as described in more detail with respect to FIGS. 2 to 5. The handpiece 10 also has a mouthpiece 32 upon which an operator inhales during an aerosolisation session to inhale the generated aerosol.

The charging unit 50 comprises a second charge storage module 51 that is configured to charge the first charge storage module 11 and power the heater 47.

The first charge storage module 11 can be one or more batteries or supercapacitors, or a combination thereof. The first charge storage module 11 can be a fast-charging battery, for example a battery with chemistry such as lithium titanate (LTO). Batteries of this type are able to deliver the high current required at the beginning of an aerosolisation session and have superior safety properties.

The second charge storage module 51 can be one or more batteries or supercapacitors, or a combination thereof. In an example, the second charge storage module 51 can be a single high energy density lithium-ion battery with moderate power capability. In another example, the second charge storage module 51 can be a combination of a high energy density lithium-ion battery with low power capabilities, and a high power battery (such as LTO, or lithium iron phosphate LFP) or a supercapacitor module.

In the following description, the first charge storage module is referred to as the handpiece battery 11, and the second charge storage module is referred to as the charging unit battery 51. However, the skilled person will readily understand that each of these can be one or more batteries, supercapacitors, or a combination thereof.

The charging unit battery 51 has a larger charge storage capacity than the handpiece battery 11. That is, the charging unit battery 51 can hold more charge the handpiece battery 11. The handpiece battery 11 may be capable of powering the heater 47 to aerosolise a first number of aerosol generating substrates, and the charging unit battery 51 may be capable of powering the heater 47 to aerosolise a second number of aerosol generating substrates, wherein the second number is greater than the first number. For example, the handpiece battery 11 may be capable of powering the heater 47 to aerosolise two aerosol generating substrates, and the charging unit battery 51 may be capable of powering the heater 47 to aerosolise twenty aerosol generating substrates.

In this way, the handpiece 10 can be dimensioned to be smaller than the charging unit 50 to be more comfortable for an operator to hold during an aerosolisation session. The larger charging unit 50 can then be used to charge the handpiece 10 between aerosolisation sessions. As such, there is a technical advantage in the provision of an aerosol generation device that has a smaller and more user-friendly handpiece 10 for aerosolisation sessions that can power a large number of sessions without needing to be connected to an external power source.

The charging unit 50 is dimensioned to receive and accommodate the handpiece 10 within an opening in the charging unit 50. The charging unit battery 51 connects by connectors in the charging unit opening to corresponding connectors in the handpiece 10 when the handpiece is received in the charging unit 50. A controller in the handpiece 10 or the charging unit 50 can detect a signal between the handpiece connectors and the charging unit connectors and control a power flow from the charging unit battery 51 to the handpiece battery 11. A power flow as discussed herein can be considered as a flow of electric charge, or a current, from one element to another. In this way, when the operator inserts the handpiece 10 into the charging unit 50, the handpiece battery 11 and charging unit battery 51 are brought into connection so that the handpiece battery 11 can be charged by the charging unit battery 51 through the connection between the connectors. As such, the charging unit 50 can be considered as a charging case for the handpiece 10. Likewise, power can flow from the charging unit battery 51 to the heater 47 by the connectors, to power the heater 47 using the charging unit battery 51.

The charging unit battery 51 can store enough charge to fully recharge the handpiece battery 11 a plurality of times. The charging unit battery 51 can itself be charged from an external power source, such as a power bank or mains source, by a connection such as a USB cable, or through connection to a docking station.

FIG. 1A shows the handpiece 10 removed from the charging unit 50 so that they are not in connection with one another. FIG. 1B shows the handpiece 10 received in and connected to the charging unit 50. In the example of FIG. 1B, the mouthpiece 32 of the handpiece 10 extends outwardly from the charging unit 50. In this way, the operator can perform an aerosolisation session whilst the handpiece 10 is housed within the charging unit 50.

Alternatively or additionally, in some examples, the charging unit 50 and handpiece 10 can be configured so that the handpiece 10 can pivot outwardly from the charging unit 50, whilst still connected to the charging unit 50, by a hinged connection at the end of the handpiece 10 away from the mouthpiece 32, as shown in FIG. 1C. This can provide greater access to the handpiece 10 whilst still connected to the charging unit 50.

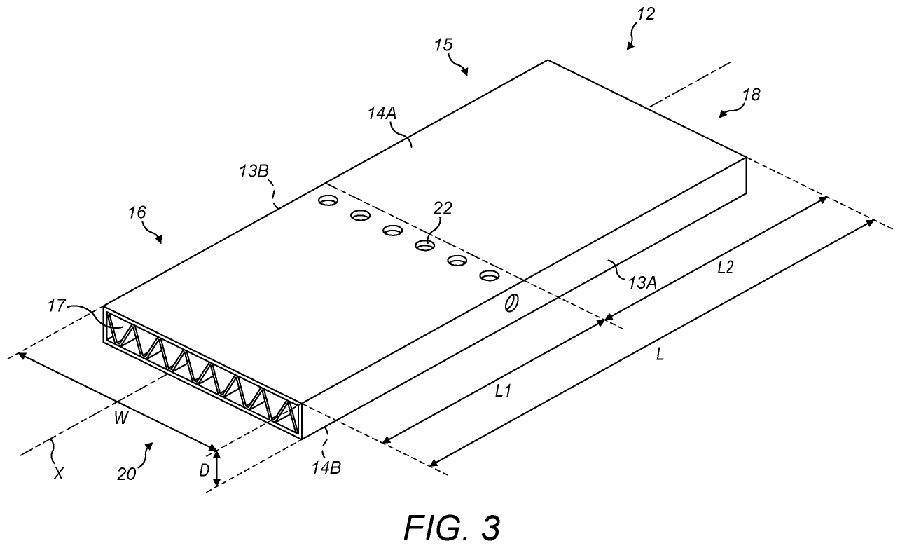

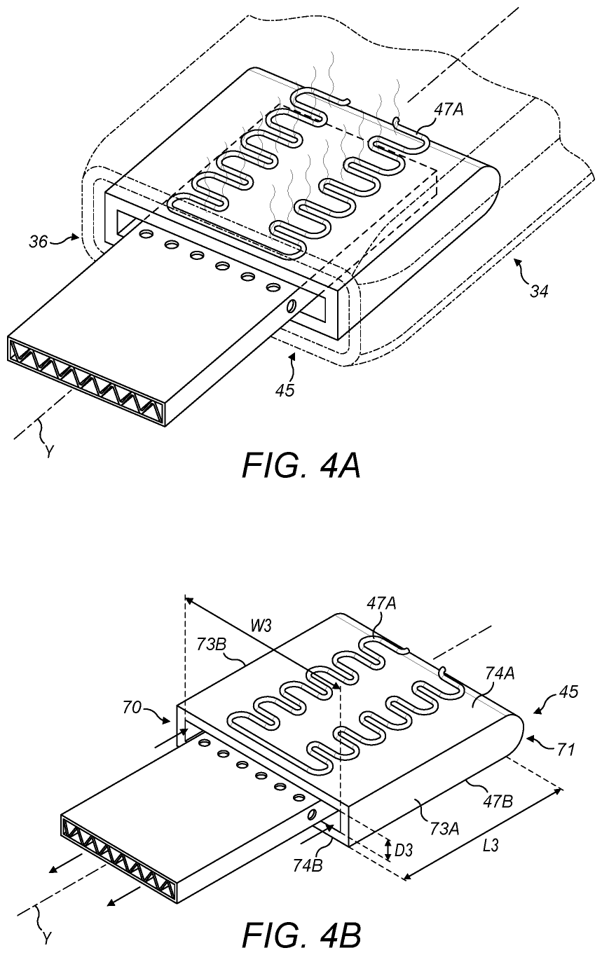

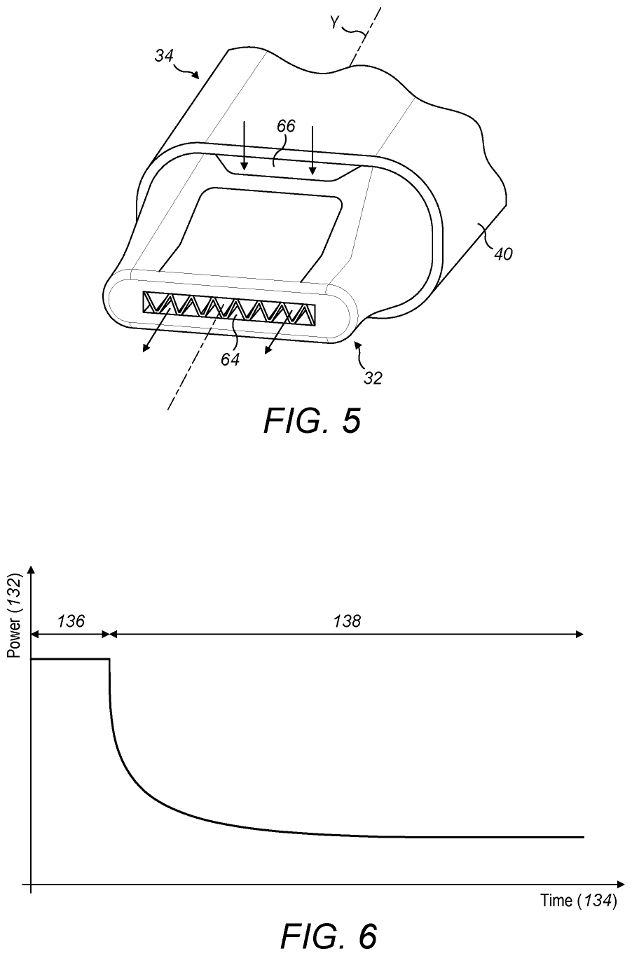

FIGS. 2 to 5 show the handpiece 10 of the first exemplary aerosol generation device 100 in more detail. FIG. 2 shows the handpiece 10 with the connected mouthpiece portion 32. FIG. 3 shows an aerosol generating substrate 12 configured for use with the handpiece 10 of FIG. 2. FIG. 4A shows a heating chamber 45 of the handpiece 10 of FIG. 2 with the aerosol generating substrate 12 of FIG. 3, and FIG. 4B shows the heating chamber 45 in more detail. FIG. 5 shows the mouthpiece portion 32 of the handpiece 10 of FIG. 2 in more detail.

The aerosol generating substrate 12 is planar or flat in shape, for example in the form of flat-shaped cuboid extending along a substrate axis X and having external dimensions L×W×D. In a specific example, the length L of the substrate according to the substrate axis X equals substantially to 33 mm, width W and depth D are substantially 12 mm and 1.2 mm, respectively. That is to say, the substrate can be considered planar in shape in that it has a depth that is much shorter than the length and width.

The depth D of the substrate 12 is formed by a pair of parallel walls 13A, 13B, referred to as substrate lateral walls 13A, 13B. The width W of the substrate is formed by a pair of parallel walls 14A, 14B, referred to as substrate contact walls 14A, 14B. In other examples, the aerosol generating substrate 12 can be of other suitable shapes or dimensions. For example, the aerosol generating substrate be in of a circular tube shape, similar to a traditional cigarette.

The aerosol generating substrate 12 can comprise a heating portion 15 and a mouthpiece part 16 arranged along the substrate axis X. However, in some examples, the aerosol generating substrate 12 may comprise only the heating portion 15. The mouthpiece part has a length L1, and the heating part has a length L2. In some examples, the heating portion 15 can be slightly longer than the mouthpiece part 16, that is, L2 can be greater than L1. The heating portion 15 defines an abutting end 18 of the substrate 12 and the mouthpiece part 16 defines a mouth end 20 of the substrate 12. The heating portion 15 and the mouthpiece part 16 may be connected by a wrapper extending around the substrate axis X. Alternatively, the parts 15, 16 may be wrapped by different wrappers and fixed one to the other by any other suitable mean. The wrapper(s) can comprise paper and/or non-woven fabric and/or aluminium. The wrapper(s) may be porous or air impermeable. The wrapper(s) can form a plurality of airflow channels extending inside the substrate 12 between the abutting end 18 and the mouth end 20.

The heating portion 14 is configured to be heated by a heater and comprises an aerosol generating material. The aerosol generating material can be a material that may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant. When the aerosol generating material is heated, an aerosol or vapour is formed. It will be understood that the terms aerosol and vapour can be used interchangeably in this description. In an example, the aerosol generating material forms an aerosol when it is heated by the heater 47 without being burned.

The mouthpiece part 16 is intended to be received inside a mouthpiece 32. The mouthpiece part 16 comprises a core 17 that can provide a filtering functionality. In some examples, the core 17 can be a foam, or packed strands of fibres. The core 17 can be formed through an extrusion and/or rolling process into a stable shape. The substrate 12 may be shaped to provide one or more airflow channels. As shown in the example of FIG. 3, the mouthpiece part 16 defines a plurality of venting holes 22 arranged on walls of the substrate, and this can include one of more of the substrate lateral walls 13A, 13B and the substrate contact walls 14A, 14B. The venting holes 22 allow fresh air entering inside the substrate 12 to achieve particular vaping/tasting effects.

The handpiece 10 comprises a handpiece body 30 extending along a handpiece axis Y and forming at least one side wall 40 of the handpiece 10. The handpiece body 30 comprises a mouthpiece 32 and a housing 34 arranged successively according to the handpiece axis Y. In the example of FIG. 1, the mouthpiece 32 and the housing 34 form two different pieces. The mouthpiece 32 is designed to be removably fixed on, or received in, an insertion opening 36 formed at one of the ends of the housing 34. This opening 36 extends perpendicularly to the handpiece axis Y as it is shown on FIG. 4 where the mouthpiece 32 is removed from the housing 34.

In each cross section, the housing 34 may for example form a substantially rectangular shape with rounded edges, with at least four side walls 40. In other examples, the housing may have at least one different cross-sectional shape, for example a round shape. The housing 34 can be sealed at the end opposite to the insertion opening 36 receiving the mouthpiece 32. The housing 34 can be formed from a single piece or several assembled pieces made of any suitable material like aluminium or plastic. One or more side walls 40 of the housing can have one or more openings for control and/or visual elements. For example, such elements can include one or more of control buttons, touch panels, screens, LEDs, etc. In an example, the housing 34 has a slot 42 for an LED indicating at least an ON state of the handpiece 10. In some examples, the LED can also indicate status information of the handpiece such as a battery state, an error state, etc.

The housing 34 contains the handpiece battery (not shown) for powering the handpiece 10, a controller 43 for controlling the operation of the handpiece 10, a heating chamber (also referred to as a heating cavity) 45 for heating the aerosol generating substrate 12 and at least two heating elements 47A, 47B for heating the heating chamber 45.

The mouthpiece 32 is configured to connect to the insertion opening 36 while assembling the mouthpiece 32 with the housing 34

The mouthpiece 32 has a through-hole along the handpiece axis Y designed to receive the mouthpiece part 16 of the aerosol generating substrate 12 so that the substrate axis X coincides with the handpiece axis Y. The through-hole can have the same cross-sectional shape as the aerosol generating substrate 12 with internal dimensions slightly greater than the external dimensions of the mouthpiece part 16 of the aerosol generating substrate 12. In an example, the through-hole defines a rectangular cross-section for receiving the mouthpiece part 16 of the aerosol generating substrate 12.

The mouthpiece 32 can have a recessed portion so that when the mouthpiece 32 is inserted in the insertion opening 36, the recess portion forms an opening 66 forming a flow inlet 66. Where the aerosol generating substrate 12 comprises the venting holes 22, at least some of these venting holes 22 are arranged to face the flow inlet 66.

Turning to FIGS. 4A and 4B in more detail, the heating chamber 45 can be cup-shaped and extend along the handpiece axis Y between an open end 70 into which the aerosol generating substrate 12 is inserted, and an opposing sealed end 71. The heating chamber 45 receives the heating portion 15 of the aerosol generating substrate 12. The heating chamber 45 has substantially the same cross-sectional shape as the aerosol generating substrate 12. In an example, the heating chamber 45 defines a rectangular cross-sectional shape with two parallel chamber lateral walls 73A, 73B and two parallel chamber contact walls 74A, 74B. The walls 74A, 74B form two major internal faces in the chamber 45, and oppose one another; the aerosol generating substrate is configured to be received between these opposing major internal faces. The major internal faces each comprise a heating element 47A, 47B of the heater component 47. The walls 73A, 73B form two minor internal faces of the chamber, connecting the two major internal faces. The two minor internal faces are smaller than the two major internal faces, and the cavity is configured to receive an aerosol generating substrate that is substantially planar in shape. Each chamber wall 74A, 74B is for example at least 3 times, advantageously 5 times and more advantageously 8 times, wider than each chamber wall 73A, 73B.

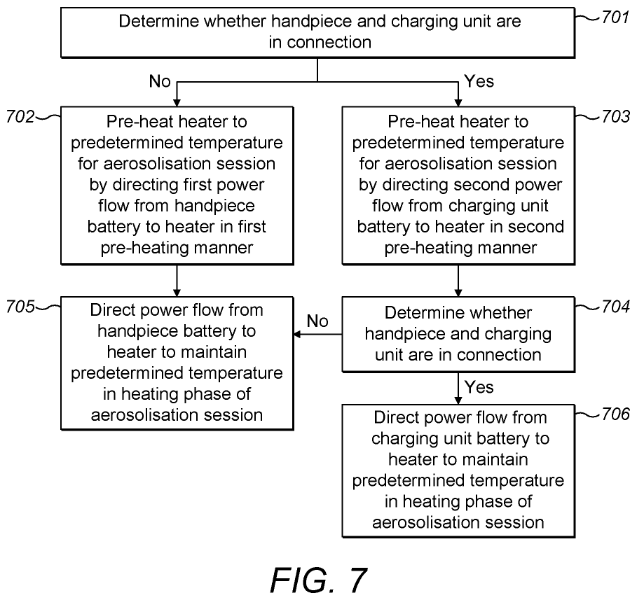

The heating chamber 45 has a distal wall arranged perpendicularly to the handpiece axis Y and sealing the sealed end 71. The distal wall is adjacent to each of the walls 73A, 73B, 74A, 74B to seal the chamber at the sealed end 71 and form a cup shape of the chamber. Each of the walls 73A, 73B, 74A, 74B, 75 can be of a thermally conductive material, such as a metal, notably a stainless steel. Additionally, at least some of the walls 73A, 73B, 74A, 74B, 75 or all of these walls can form one single piece. Alternatively, the walls 74A, 74B can be ceramic with heater wires or tracks embedded therein or thereon. The walls 73A, 73B and 75 can also be ceramic. Such a ceramic heater can provide a compact heating cavity with well-distributed heat directed to the substrate. However, it can require considerably more power to heat (e.g. >>10 W and/or >>1600 J) than the heater of an aerosol generation device that is configured to receive a more traditional cigarette or cigarette-like consumable. Such heaters therefore greatly benefit from the heating power management operations subsequently with reference to FIG. 7.

The internal dimensions of the heating chamber 45 are defined by the length L3 measured according the handpiece axis Y, the width W3 measured as the distance between the chamber lateral walls 73A, 73B and the depth D3 measured as the distance between the chamber contact walls 74A, 74B. These internal dimensions L3, W3, D3 are chosen basing on the external dimensions L2, W, D of the heating portion 15 of the aerosol generating substrate 12.

The depth D3 of the heating chamber 45 can be slightly greater than the depth D of the aerosol generating substrate 12 or substantially equal to this depth D. In this case, the substrate contact walls 14A, 14B can be in contact with the chamber contact walls 74A, 74B and notably with contact surfaces of these walls 74A, 74B, when the heating portion 15 of the of the aerosol generating substrate 12 is received inside the heating chamber 45. Advantageously, in this case, the chamber contact walls 74A, 74B and notably their contact surfaces, are in a tight contact with the substrate contact walls 14A, 14B. In other examples, the depth

D3 of the heating chamber 45 can be slightly less than the normal depth D of the aerosol generating substrate 12. In this case, the heating chamber 45 and/or the mouthpiece 32 is (are) configured to compress the heating portion 15 of the aerosol generating substrate 12 by exerting force on the substrate contact walls 14A, 14B. This makes it possible to improve the tight contact between the corresponding contact walls of the heating chamber 45 and the substrate 12 and thus, to improve heat transfer between these walls.

The width W3 of the heating chamber 45 can be defined so as at least one pair of facing lateral walls 73A, 13A or 73B, 13B of the heating chamber 45 and the aerosol generating substrate 12 forms an airflow channel between them. When the heating portion 15 of the aerosol generating substrate 12 is inserted in the heating chamber 45, an airflow channel is formed along the handpiece axis Y on either lateral side of the aerosol generating substrate 12. In an alternative, no airflow channel between the pairs of facing lateral walls 73A, 13A or 73B, 13B of the heating chamber 45 and the aerosol generating substrate 12 is formed. Instead, the pairs of lateral walls 73A, 13A or 73B, 13B may be in contact. This is suitable when the distal wall 75 or any other wall of the heating chamber 45 forms an opening suitable for air entering.

The walls 74A and 74B of the chamber 45 each have a heating element 47A, 47B. The heating elements 47A, 47B form the heater 47 (also referred to as a heater component) of the device. In an example, the heating elements 47A, 47B can be arranged in contact with one of the chamber contact walls 74A, 74B outside of the heating chamber 45. In the example of FIG. 4B, the heating element 47A is arranged adjacent to an outer surface of the chamber contact wall 74A and the heating element 47B is arranged adjacent to an outer surface of the chamber contact wall 47A. Thus, the chamber contact walls transfer heat from the heating elements 47A, 47B to the aerosol generating substrate 12. Each heating element 47A, 47B may comprise a polyimide film heater extending along substantially the total area of said outer surface of the corresponding heating wall 74A, 74B or only along a part of this surface. In other examples, the heating elements can be embedded within the chamber walls. For example, the heating element 47A can be embedded in the chamber contact wall 74A, and the heating element 47B can be embedded in the chamber contact wall 74B. In a further example, the heating elements can be on the chamber walls, internal to the heating chamber 45.

Optionally, the handpiece 10 can also include an insulator arranged between each heating element 47A, 47B and an inner surface of the housing 34. The same insulator may also be arranged between an outer surface of each of the chamber lateral walls 73A, 73B and the inner surface of the housing 34.

The handpiece 10 comprises a controller 43. The controller 43 is configured to control the operation of the handpiece 10. This can include inhibiting and enabling the operation of the device, as well as controlling a power flow of the handpiece battery 11 and the charging unit battery 51 (when connected), based upon an operating mode of the aerosol generation device 100.

The controller 43 can be at least one microcontroller unit comprising memory, with instructions stored thereon for operating the handpiece 10, including instructions for inhibiting and enabling the operation of the device, instructions for executing operating modes of the device, instructions for controlling the power flow from the battery, and the like, and one or processors configured to execute the instructions.

The controller 43 may be configured to operate separately the operation of each heating element 47A, 47B, according to a heating profile chosen among a predetermined group of heating profiles. The corresponding heating profile may be chosen according to a mode of operation of the handpiece 10 and/or according to at least some external/internal parameters relative to the operation of the handpiece 10.

The controller 43 controls a power flow to the heater 47 in the aerosolisation session, wherein an aerosolisation session can include a pre-heating phase and a heating phase.

In the pre-heating phase, the heater 47 is heated to a predetermined temperature for the generation of an aerosol from the aerosol generating substrate 12. The pre-heating phase can be considered the time during which a pre-heating mode is being executed, for example the time it takes for the heater 47 to reach the predetermined temperature. The pre-heating mode occurs during a first time period of the aerosolisation session. In an example, the first time period can be a fixed pre-determined time period. In other examples, the first time period can vary corresponding to the length of time needed to heat the heater 47 to the predetermined temperature. The predetermined temperature can be stored in memory accessible by the controller.

When the pre-heating phase is complete, the controller 43 ends the pre-heating mode and controls a power flow to the heater 47 to power the heating phase. In the heating phase, the controller 43 controls the power flow to the heater 47 to maintain the heater 47 substantially at the predetermined temperature so that an aerosol is generated for the consumer to inhale. A heating phase can be considered the time during which a heating mode is being executed, for example the time during which the heater 47 is aerosolising one (or at least part of one) aerosol generating substrate 12 after the pre-heating phase. The controller 43 can control the power flow to the heater 47 in the heating mode for a second time The second time period can be period of the aerosolisation session. predetermined and stored at the controller 43.

FIG. 6 shows an exemplary plot of average power 132 delivered to the heater 47 against time 134 for an aerosolisation session. In the pre-heating phase, the controller 43 controls the power flow to the heater 47 to apply power to the heater 47 for the first time period 136, until the heater 47 temperature reaches the predetermined temperature. In an example, the predetermined temperature may be 230° C. In an example, the first time period is 20 seconds. In some examples, the controller 43 is configured to heat the heater 47 to the predetermined temperature within a fixed predetermined first time period. In other examples, the first time period varies depending on how long the heater 47 takes to reach the predetermined temperature.

When the heater 47 reaches the predetermined temperature, the controller 43 switches the operating mode to the heating phase for the second time period 138 and maintains the heater 47 temperature substantially at the predetermined temperature for this second time period 138. In an example, the second time period may be 250 seconds. Typically, a lower power level is applied to the heater 47 in the heating phase when maintaining the heater 47 at the predetermined temperature, than the power level applied to the heater 47 to heat it to the predetermined temperature in the pre-heating phase. This can be seen in FIG. 6 in that the power delivered to the heater 47 in the second time period 138 is lower than the power delivered to the heater 47 in the first time period 136. The power level delivered to the heater 47 can be controlled by various means, for example adjusting the power output from the battery/batteries, or by adjusting the on/off periods in a pulse width modulated power flow.

Following the aerosolisation session the user of handpiece 10 may be informed that the aerosolisation session has ended, by way of a visual, haptic or audible indicator for example, so that they are aware that the substrate is no longer being aerosolised.

FIG. 7 shows an operational flow chart of a control process for power management in an aerosolisation session, by which power is controlled between the handpiece battery 11, charging unit battery 51 and the heater 47 in an aerosolisation session.

At step 701, the controller determines whether the handpiece 10 and charging unit 50 are in connection with one another. In an example, the controller of the handpiece 10 can determine that the handpiece 10 is connected to the charging unit 50 by detecting a signal between the connectors of the handpiece 10 and the connectors of the charging unit 50 when the handpiece 10 and charging unit 50 are in connection with one another. Likewise, the controller of the handpiece 10 can determine that the handpiece 10 is not connected to the charging unit 50 by detecting no signal between the connectors of the handpiece 10 and the connectors of the charging unit 50 when the handpiece 10 and charging unit 50 are not in connection with one another.

Prior to step 701, the controller can determine whether an aerosolisation session has been triggered. In some examples, the controller may determine that an aerosolisation session has been triggered in response to a user input, for example the pressing or operating of a button (for example an ‘ON’ button) on the aerosol generation device that a user can press or operate to begin an aerosolisation session. In response to determining that an aerosolisation session has been triggered, the controller can be configured to perform step 701.

When the controller determines that the handpiece 10 and the charging unit 50 are not in connection with one another, at step 701, the process proceeds to step 702. When the controller determines that the handpiece 10 and the charging unit 50 are in connection with one another, the process proceeds to step 703.

At step 702, the controller is configured to pre-heat the heater 47 in the pre-heating phase to a predetermined temperature for an aerosolisation session by directing a first power flow from the handpiece battery 11 to the heater 47 in a first pre-heating manner. This can take place in response to the controller determining that an aerosolisation session has been triggered. The controller can also determine when the pre-heating phase has been completed, at step 702. In some examples, the pre-heating phase may be determined to be completed when the controller determines that a predetermined pre-heating time period, stored in memory accessible by the controller, has expired. In other examples, the pre-heating phase may be determined to be completed when the controller determines that a predetermined heater temperature, stored in memory accessible by the controller, has been reached by monitoring a temperature associated with the heater 47 using a temperature sensor. Following completion of the pre-heating at step 702, the process continues to step 705.

As has been described, when the controller determines that the handpiece 10 and the charging unit 50 are in connection with one another, at step 701, the process continues to step 703. At step 703, the controller is configured to pre-heat the heater 47 in the pre-heating phase to the predetermined temperature for an aerosolisation session by directing a second power flow from the charging unit battery 51 to the heater 47 in a second pre-heating manner. This can take place in response to the controller determining that an aerosolisation session has been triggered.

In a first example of the second power flow, the controller controls the charging unit battery 51 such that the heater 47 is powered only by the charging unit battery 51. In a second example of the second power flow, the controller controls both the charging unit battery 51 and the handpiece battery 11 to power the heater 47. In the first example, the charge in the handpiece battery 11 can be saved for the heating phase. In the second example, the charging unit battery 51 can be used to boost the power flow from the handpiece battery 11 for a more rapid heating phase.

The controller can also determine when the pre-heating phase has been completed at step 703. In some examples, the pre-heating phase may be determined to be completed when the controller determines that a predetermined pre-heating time period, stored in memory accessible by the controller, has expired. In other examples, the pre-heating phase may be determined to be completed when the controller determines that a predetermined heater temperature, stored in memory accessible by the controller, has been reached by monitoring a temperature associated with the heater 47 using a temperature sensor. Following completion of the pre-heating at step 703, the process continues to step 704.

In more detail, for the first pre-heating manner, the controller can be configured direct the first power flow from the handpiece battery 11 to the heater 47 for a first predetermined period of time. For the second pre-heating manner, the controller can be configured to direct the second power flow from the charging unit battery 51 to the heater 47 for a second predetermined period of time.

As already described, the handpiece battery 11 can be smaller than the charging unit battery 51. As well as this, the handpiece battery 11 can be a battery type that is suited to fast charging, rather than having a high power output. Consequently, the handpiece battery 11 can have a lower power output than the charging unit battery 51.

As such, the first predetermined period of time can be longer than the second predetermined period of time, and the first power flow can be a lower power than second power flow. In this way, the pre-heating phase in the first pre-heating manner can take a longer time, using a lower power level, than the pre-heating phase in the second pre-heating manner that uses a higher power level.

In an example, the first predetermined period of time may be 50 seconds, and the second predetermined period of time may be 20 seconds.

This option between the first pre-heating manner and the second pre-heating manner provides the operator with flexibility in the aerosolisation session. The operator has a choice between:
(a) a slower pre-heating in the first pre-heating manner, but with the advantage of not needing to have the handpiece 10 connected to the charging unit 50 thereby leading to improved comfort in needing only the smaller handpiece 10; or
(b) a quicker pre-heating in the second manner, but requiring the smaller handpiece 10 to be connected to the larger charging unit 50.

After the pre-heating phase at step 702, in which the first power flow from the handpiece battery 11 is directed to the heater 47 for the pre-heating phase the process progresses to step 705. At step 705, the controller is configured to direct a power flow from the handpiece battery 11 to the heater 47 to maintain the predetermined temperature in the heating phase of the aerosolisation session.

In this way, both the pre-heating phase and the heating phase can be carried out with the handpiece 10 not connected to the charging unit 50. As such, the operator only needs the handpiece 10, which is smaller, and more user friendly to operate. The operator can perform the entire aerosolisation session without needing the charging unit 50, albeit requiring a longer pre-heating time. This can be advantageous if, for example, the operator wishes to leave the charging unit 50 on their desk whilst moving to a different area to perform the aerosolisation session, rather than carrying both units of the overall device.

This presumes that the handpiece 10 has not been reconnected to the charging unit 50 after the pre-heating phase. In an alternative, the controller can determine whether the handpiece 10 and charging unit 50 are in connection with one another before initiating the heating mode, and then direct a power flow from the handpiece battery 11 to the heater 47 when they are not connected, or direct a power flow from the charging unit battery 51 to the heater 47 when they are connected.

After the pre-heating phase at step 703, in which the second power flow from the charging unit battery 51 is directed to the heater 47 for the pre-heating phase the process progresses to step 704.

At step 704, the controller can be configured to determine whether the handpiece 10 and charging unit 50 are still in connection with one another before initiating the heating phase. When the controller determines that the handpiece 10 and the charging unit 50 are not in connection with one another, at step 704, the process proceeds to step 705. When the controller determines that the handpiece 10 and the charging unit 50 are in connection with one another, the process proceeds to step 706.

In an example, at step 704, the controller 43 determines whether the handpiece 10 and charging unit 50 have or have not been disconnected by determining whether there is no signal between the connectors of the two units (they have been disconnected), or whether there still is a signal between the connectors of the two units (the have not been disconnected).

At step 705, the controller is configured to direct a power flow from the handpiece battery 11 to the heater 47 to maintain the predetermined temperature in the heating phase of the aerosolisation session.

In this way, a rapid pre-heating can be performed at step 703, using the more powerful charging unit battery 51. This allows for the size of the battery in the handpiece 10 to be minimised through using a smaller and less powerful battery, thereby also reducing the overall size of the handpiece 10. Then, in a user-friendly manner, only the smaller handpiece 10 needs to be handled for heating phase as the handpiece battery 11 powers the heating phase. The handpiece 10 and the charging unit 50 do not need to be lifted to user mouth in pre-heating phase; as such the benefits of rapid pre-heating are combined with the benefits of only having to lift the smaller more user friendly handpiece 10 during heating phase.

Therefore, this configuration is advantageous to both the pre-heating phase and the heating phase by combining the benefits of rapid pre-heating and only needing to bring the smaller more user-friendly component (the handpiece 10) to the mouth for inhalation of the generated aerosol in the heating phase.

As has been described, when the controller determines that the handpiece 10 and the charging unit 50 are in connection with one another for the heating phase of the aerosolisation session, at step 704, the process continues to step 706.

At step 706, the controller is configured to direct a power flow from the charging unit battery 51 to the heater 47 to maintain the predetermined temperature in the heating phase of the aerosolisation session.

In this way, the charge level of the handpiece battery 11 can be preserved for subsequent aerosolisation session in which the handpiece 10 and charging unit 50 are not in connection with one another.

In a first example of directing the power flow from the charging unit battery 51 to the heater 47 at step 706, the controller controls the charging unit battery 51 such that the heater 47 is powered only by the charging unit battery 51. In a second example of directing the power flow from the charging unit battery 51 to the heater 47 at step 706, the controller controls both the charging unit battery 51 and the handpiece battery 11 to power the heater 47. In the first example, the charge in the handpiece battery 11 can be saved for a subsequent aerosolisation session. In the second example, the charging unit battery 51 can be used to boost the power flow from the handpiece battery 11, to reduce the charge drawn from the handpiece battery 11 thereby saving charge for a subsequent aerosolisation session.

Optionally, the controller can monitor the charge level of the handpiece battery 11 and control an indicator (such as a visual, audible or haptic indicator) in the aerosol generation device 100 to output a first indication when the handpiece battery 11 does not have sufficient charge to power a heating phase alone, and/or a different second indication when the handpiece battery 11 does have sufficient charge to power a heating phase alone. In this way, the user can be made aware that the two units cannot/can be disconnected for the heating phase. This can inform the user as to whether it is suitable to disconnect the handpiece 10 and the charging unit 50 before the heating phase, with this internal state information.

In addition to the power management processes described with reference to FIG. 7, the controller can be further configured to direct a power flow from the charging unit battery 51 to the handpiece battery 11 to charge the handpiece battery 11 when the handpiece 10 is connected to the charging unit 50. In a first example, this charging can take place between aerosolisation sessions. In a second example, the controller can be configured to direct the power flow from the charging unit battery 51 to the handpiece battery 11 to charge the handpiece battery 11 both between aerosolisation sessions and during aerosolisation sessions. In this way, the handpiece battery 11 can be charged for example during the pre-heating phase, and therefore readied for a heating phase when disconnected from the charging unit 50.

The power management control process described with reference to FIG. 7 is advantageous, through the flexibility in the operation of the aerosol generating device, by the provision of user-selectable pre-heating and heating power control options.

The operator can choose to keep the handpiece 10 and charging unit 50 disconnected for both the pre-heating phase and the heating phase (i.e. the entire aerosolisation session). The provision of the smaller handpiece battery 11 allows for the handpiece 10 itself to be smaller, thereby making it more comfortable for the operator to hold. This reduction in battery size (and output power) is compensated for by increasing the pre-heating time. As such, the operator can carry out a full aerosolisation session without needing to handle the charging unit 50, but with the compromise of an increased pre-heating time. This option is described in the flow of steps from 701 to 702 to 705.

On the other hand, if the operator desires a faster pre-heating, the operator can choose to keep the handpiece 10 and charging unit 50 connected for the pre-heating phase, utilising the more powerful charging unit battery 51 to power the heater 47 for the pre-heating.

Then, the operator can then disconnect the handpiece 10 from the charging unit 50 for the heating phase. This allows for both rapid pre-heating with the larger charging unit battery 51, during which the device is not brought to the operator's mouth, coupled with improved usability in only needing to lift the smaller handpiece 10 to the mouth to inhale the generated aerosol during the heating phase. This option is described in the flow of steps from 701 to 703 to 704 to 705.

Alternatively, the operator can elect keep the handpiece 10 and charging unit 50 connected for both the pre-heating phase and the heating phase (i.e. the entire aerosolisation session). This can be beneficial, for example, when the operator wishes to preserve charge in the handpiece battery 11 for further aerosolisation sessions, or wishes to perform another aerosolisation session before the handpiece battery 11 has had adequate time to recharge. This option is described in the flow of steps from 701 to 703 to 704 to 706.

The power management control process of FIG. 7 can also be implemented in a number of manners for when an operator wishes to carry out two consecutive aerosolisation sessions. In some examples, this may be when an operator wishes to aerosolise two substrates, or when a second operator wishes to aerosolise a second substrate using the same aerosol generation device after the first operator has aerosolised the first substrate.

In a first example of consecutive aerosolisation sessions, the handpiece 10 and charging unit 50 can be disconnected for both pre-heating and heating phases of the first aerosolisation session (such as in the process of steps 701 to 702 to 705). Then, for the second aerosolisation session, the handpiece 10 and charging unit 50 can still be disconnected for the pre-heating phase (such as in step 702). However, the handpiece battery 11 may not have sufficient charge remaining to power the heating phase of the second aerosolisation session. As such, the handpiece 10 and charging unit 50 can be brought into connection for the heating phase of the second aerosolisation session so that the charging unit battery 51 can power the heater 47. In this case, an additional determination of whether the handpiece 10 and charging unit 50 are in connection may occur following step 702, although this is not shown in FIG. 7. In this example, the controller can monitor the charge level of the handpiece battery 11 and control an indicator (such as a visual, audible or haptic indicator) in the aerosol generation device to output an indication when the handpiece battery 11 does not have sufficient charge to power the heating phase of the second aerosolisation session. This indication can be configured to alert the operator that the handpiece 10 and charging unit 50 will need to be brought into connection for the heating phase of the second aerosolisation session to be carried out.

In a second example of consecutive aerosolisation sessions, the handpiece 10 and charging unit 50 can still be disconnected for both the pre-heating phase and the heating phase of the first aerosolisation session (such as in the process of steps 701 to 702 to 705). Then, for the second aerosolisation session, the handpiece 10 and charging unit 50 can be connected for the pre-heating phase (such as in step 703). By powering the pre-heating phase of the second aerosolisation session using the charging unit battery 51, the charge level in the handpiece battery 11 can be preserved for the heating phase of the second aerosolisation session. Additionally, the handpiece battery 11 can be charged by the charging unit battery 51 whilst the handpiece 10 and charging unit 50 are connected during the pre-heating phase of the second aerosolisation session. Furthermore, the operator benefit from the faster pre-heating for the second aerosolisation session by using the more powerful charging unit battery 51. As such, the handpiece 10 can then be disconnected from the charging unit 50 for the heating phase of the second aerosolisation session (such as in step 705), with a sufficient charge level to power the heating phase of the second aerosolisation session.

In a third example of consecutive aerosolisation sessions, the handpiece 10 and charging unit 50 can be disconnected for both the pre-heating phase and the heating phase of the first aerosolisation session (such as in the process of steps 701 to 702 to 705). Then, for the second aerosolisation session, the handpiece 10 and the charging unit 50 can be connected for both the pre-heating phase and the heating phase of the second aerosolisation session (such as in the process of steps 701 to 703 to 704 to 706). This is advantageous in allowing consecutive aerosolisation sessions to be performed when the handpiece battery 11 is too small (and cannot store enough charge) to power more than one aerosolisation session, or cannot be sufficiently recharged during the second (rapid) pre-heating phase when connected to the charging unit 50, to then power the second heating phase alone when disconnected. That is, a smaller handpiece battery 11 can be used that only has the capacity to power one pre-heating phase and one heating phase. This allows for a reduced handpiece 10 size, due to the smaller battery, whilst still allowing consecutive aerosolisation sessions to be performed.

In a fourth example of consecutive aerosolisation sessions, the handpiece 10 and the charging unit 50 can be connected for the pre-heating phase of the first aerosolisation session, and the disconnected for the heating phase of the first aerosolisation session (such as in the process of steps 701 to 703 to 704 to 705). Then, the handpiece 10 and the charging unit 50 can be connected for the pre-heating phase of the second aerosolisation session, and the disconnected for the heating phase of the second aerosolisation session (such as in the process of steps 701 to 703 to 704 to 705). In this way, the benefits of the fast pre-heating using the charging unit battery 51 are achieved for both aerosolisation sessions, whilst allowing the operator to comfortably hold only the handpiece 10 for the heating phases. For this arrangement, the handpiece battery 11 can be configured to store enough charge to power two heating phases, or can be configured to recharge sufficiently during the second pre-heating phase to power the second heating phase.

In a fifth example of consecutive aerosolisation sessions, both aerosolisation sessions are fully powered by the handpiece battery 11. That is, the handpiece 10 and charging unit 50 can be disconnected for both pre-heating and heating phases of the first aerosolisation session (such as in the process of steps 701 to 702 to 705). Then, the handpiece 10 and charging unit 50 can be disconnected for both pre-heating and heating phases of the second aerosolisation session (such as in the process of steps 701 to 702 to 705). For this arrangement, the handpiece battery 11 can be configured to store enough charge to power at least two pre-heating phases and at least two heating phases. This provides the operator with the flexibility to perform two aerosolisation sessions without relying on the charging unit 50, albeit with the longer pre-heating phase powered by the handpiece battery 11. However, the operator still has the option to connect the handpiece 10 to the charging unit 50 for a more rapid pre-heating phase if they wish.

In a sixth example of consecutive aerosolisation sessions, for both aerosolisation sessions the handpiece 10 and charging unit 50 are connected. That is, the handpiece 10 and charging unit 50 can be connected for both pre-heating and heating phases of the first aerosolisation session (such as in the process of steps 701 to 703 to 704 to 706). Then, the handpiece 10 and charging unit 50 can be connected for both pre-heating and heating phases of the second aerosolisation session (such as in the process of steps 701 to 703 to 704 to 706). In this way, the heater 47 is powered by the charging unit battery 51 for both the pre-heating phase and heating phase of both aerosolisation sessions. This benefits from rapidly pre-heating in both sessions, whilst also preserving the handpiece battery 11 charge level for further aerosolisation sessions after the second aerosolisation session, for example a third aerosolisation session, powered (at least in part) by the handpiece battery 11 alone.

In a seventh example of consecutive aerosolisation sessions, the handpiece 10 and the charging unit 50 can be connected for the pre-heating phase of the first aerosolisation session, and then disconnected for the heating phase of the first aerosolisation session (such as in the process of steps 701 to 703 to 704 to 705). Then, the handpiece 10 and the charging unit 50 can be connected for the pre-heating phase of the second aerosolisation session, and the disconnected for the heating phase of the second aerosolisation session (such as in the process of steps 701 to 703 to 704 to 705). During the pre-heating phases, the controller controls both the charging unit battery 51 and the handpiece battery 11 to power the heater 47. In this way, the charging unit battery 51 can be used to boost the power flow to the heater 47 by being combined with the power flow from the handpiece battery 11 for a more rapid heating phase.

In an eighth example of consecutive aerosolisation sessions, the handpiece 10 and the charging unit 50 can be connected for the pre-heating phase of the first aerosolisation session, and then disconnected for the heating phase of the first aerosolisation session (such as in the process of steps 701 to 703 to 704 to 705). Then, the handpiece 10 and charging unit 50 can be connected for both pre-heating and heating phases of the second aerosolisation session (such as in the process of steps 701 to 703 to 704 to 706). In this way, a minimised battery size in the handpiece 10 can be utilised. This is because the handpiece battery 11 will only need to store enough charge for the heating phase of one aerosolisation sessions (e.g. the first aerosolisation session), whilst still allowing for the aerosol generation device to power consecutive aerosolisation sessions.

In a ninth example of consecutive aerosolisation sessions, the handpiece 10 and the charging unit 50 can be connected for the pre-heating phase of the first aerosolisation session, and then disconnected for the heating phase of the first aerosolisation session (such as in the process of steps 701 to 703 to 704 to 705). Then, the handpiece 10 and charging unit 50 can be connected for both pre-heating and heating phases of the second aerosolisation session (such as in the process of steps 701 to 703 to 704 to 706). This example is similar to the eighth example, except the controller can be configured to power the pre-heating phases of the first aerosolisation session and the second aerosolisation session using both the handpiece battery 11 and the charging unit battery 51. The same advantages are achieved as for the eighth example, but also the charging unit battery 51 can be used to boost the power flow to the heater 47 by being combined with the power flow from the handpiece battery 11 for a more rapid heating phase.

In the seventh and ninth examples, the handpiece battery 11 can be considered to support the charging unit battery 51 in the pre-heating phase. This can be brought about by the handpiece battery delivering it's maximum discharging rate (e.g. as specified by the battery manufacturer) to the heater (which could be less than the heater requires), combined with a much higher discharging rate from the charging unit battery, to achieve the necessary power to the heater for pre-heating (e.g. within the desired pre-heating time, for example 20 seconds). For example, the handpiece battery 11 could support the charging unit battery 51 by delivering its maximum current (e.g. 1A). At the same time, the current delivered by charging unit battery 51 could be significantly higher than that delivered by the handpiece battery 11 (e.g. 5 times higher).

In some cases a predetermined wait time (for example 30 seconds) may be required, with the handpiece 10 connected to the charging unit 50, between completing the first aerosolisation session and starting the second aerosolisation session, particularly when the handpiece 10 was disconnected from the charging unit 50 for the heating phase of the first aerosolisation session and may have a depleted battery charge level. This is to allow the handpiece battery 11 adequate time to recharge from the charging unit battery 51 for the second aerosolisation session, particularly if the handpiece 10 is to be disconnected from the charging unit 50 for the pre-heating phase in the second aerosolisation session. The controller 43 can control an indicator (such as a visual, audible or haptic indicator) in the aerosol generation device 100 to indicate to the operator when the predetermined wait time is complete.

Whilst only two consecutive aerosolisation sessions have been described, it will be understood that more than two can be performed. Indeed, consecutive aerosolisation sessions can be performed for as long as the charging unit battery 51 has enough capacity.

Some of these exemplary power management regimes for consecutive aerosolisation sessions are summarised in Table 1. It will be readily understood that the aforementioned examples of consecutive aerosolisation sessions are not the only ways that they can be performed. Any combination of pre-heating and heating phases described with reference to FIG. 7 can be executed for each of the consecutive aerosolisation sessions.

TABLE 1
Exemplary Power Management Regimes

| Power | 1st Session | 1st Session | 2nd Session | 2nd Session |
|---|---|---|---|---|
| Management | Pre-Heating | Heating | Pre-Heating | Heating |
| Regime | Powered By: | Powered By: | Powered By: | Powered By: |
| Option 1 | Handpiece | Handpiece | Handpiece | Charging unit |
| | battery | battery | battery | battery |
| Option 2 | Handpiece | Handpiece | Charging unit | Handpiece |
| | battery | battery | battery | battery |
| Option 3 | Handpiece | Handpiece | Charging unit | Charging unit |
| | battery | battery | battery | battery |
| Option 4 | Charging unit | Handpiece | Charging unit | Handpiece |
| | battery | battery | battery | battery |
| Option 5 | Handpiece | Handpiece | Handpiece | Handpiece |
| | battery | battery | battery | battery |
| Option 6 | Charging unit | Charging unit | Charging unit | Charging unit |
| | battery | battery | battery | battery |
| Option 7 | Charging unit | Handpiece | Charging unit | Handpiece |
| | battery and | battery | battery and | battery |
| | handpiece | | handpiece | |
| | battery | | battery | |
| Option 8 | Charging unit | Handpiece | Charging unit | Charging unit |
| | battery | battery | battery | battery |
| Option 9 | Charging unit | Handpiece | Charging unit | Charging unit |
| | battery and | battery | battery and | battery |
| | handpiece | | handpiece | |
| | battery | | battery | |

In the preceding control processes, when the handpiece 10 and the charging unit 50 are not in connection with one another the functionality performed by components in the handpiece 10 may be controlled by the controller in the handpiece 10, and the functionality performed by the components in the charging unit 50 may be controlled by a controller in the charging unit 50. When the handpiece 10 and the charging unit 50 are in connection with one another, all of the functionality performed by the components in the handpiece 10 and the charging unit 50 may be controlled by the controller in the charging unit 50. In an alternative, when the handpiece 10 and the charging unit 50 are in connection with one another, all of the functionality performed by components in the handpiece 10 and the charging unit 50 may be controlled by the controller in the handpiece 10. In another alternative, when the handpiece 10 and the charging unit 50 are in connection with one another some of the functionality performed by the components in the handpiece 10 and the charging unit 50 may be controlled by the controller in the charging unit 50, and some of the functionality performed by components in the handpiece 10 and the charging unit 50 may be controlled by the controller in the handpiece 10.

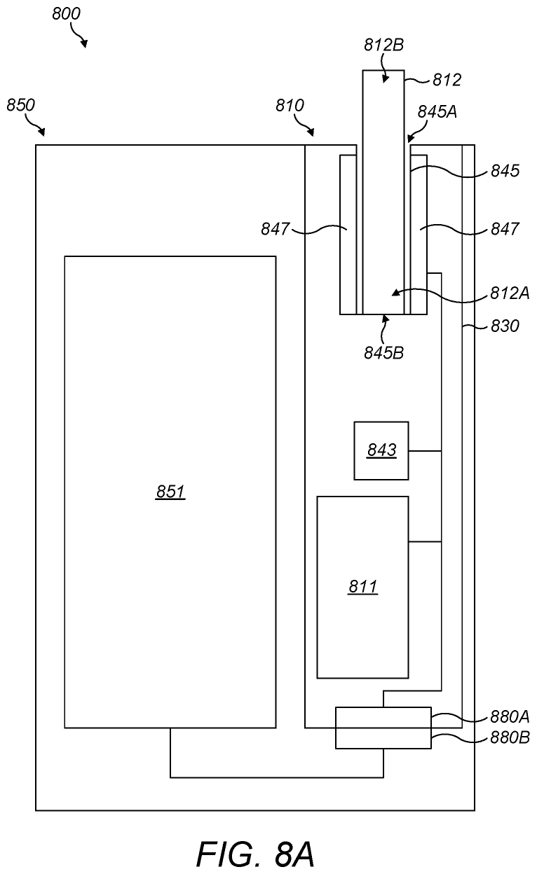

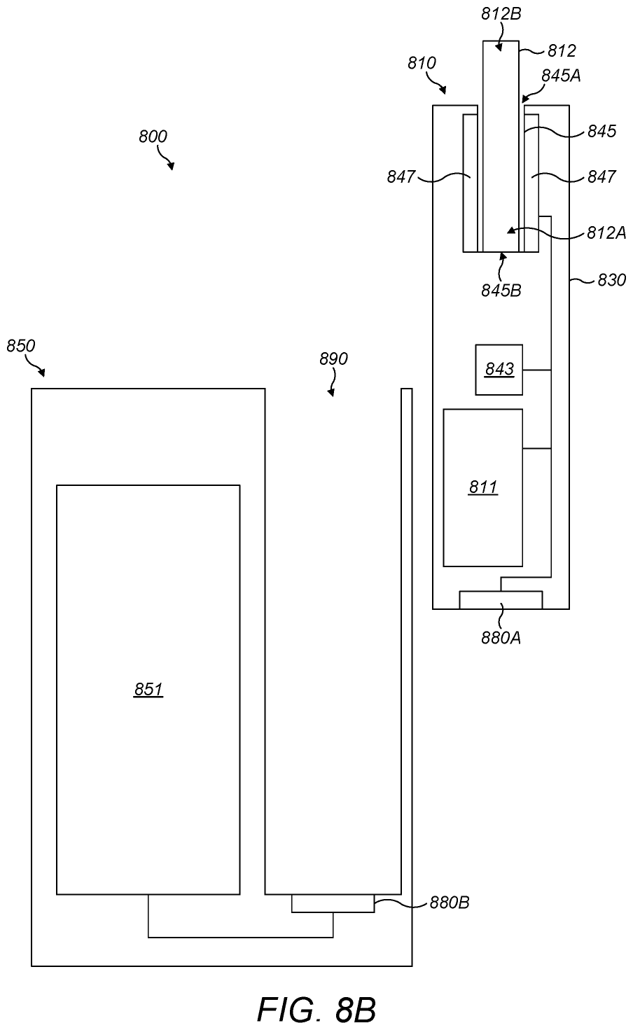

FIGS. 8A and 8B shows a second exemplary aerosol generation device 800. The second exemplary aerosol generation device 800 is configured to operate in a corresponding manner to the first exemplary aerosol generation device 100, and as such, the specific detail of the operating processes are not repeated for brevity. It will be readily understood that the operating process described with reference to the first exemplary aerosol generation device 100 (FIGS. 1 to 7) can be readily applied to the second exemplary aerosol generation device 800. It will also be readily understood that the components described with reference to the first exemplary aerosol generation device 100 can be readily applied to the second exemplary aerosol generation device 800 described with reference to FIGS. 8A and 8B, even if not mentioned with reference to FIGS. 8A and 8B for brevity.

The second exemplary aerosol generation device 800 comprises a handpiece or holding unit 810 and a charging unit or charging case 850, in a similar way to the first exemplary aerosol generation device 100. The handpiece 810 is removably connectable to the charging unit 850. FIG. 8A shows the handpiece 810 connected to the charging unit 850, and FIG. 8B shows the handpiece 810 disconnected from the charging unit 850.

The handpiece 810 comprises a first charge storage module 811 configured to power a heater 847, and provide the same functionality as the first charge storage module 11 of the of the first exemplary aerosol generation device 100. The first charge storage module 811 can be one or more batteries or supercapacitors, or a combination thereof. The first charge storage module 11 can be a fast-charging battery, for example a battery with chemistry such as lithium titanate (LTO). Batteries of this type are able to deliver the high current required at the beginning of an aerosolisation session and have superior safety properties.

The charging unit 850 comprises a second charge storage module 851 that is configured to charge the first charge storage module 811 and power the heater 847, and provide the same functionality as the second charge storage module 51 of the of the first exemplary aerosol generation device 100. The second charge storage module 851 can be one or more batteries or supercapacitors, or a combination thereof.

In the following description of the second exemplary aerosol generation device 800, the first charge storage module is referred to as the handpiece battery 811, and the second charge storage module is referred to as the charging unit battery 851. However, the skilled person will readily understand that each of these can be one or more batteries, supercapacitors, or a combination thereof.

The handpiece 810 comprises a controller 843 configured to provide corresponding functionality to controller 43 in the handpiece 11 of the first exemplary aerosol generation device 100.

The handpiece 811 has a body portion or housing 812 containing the controller 843, and the handpiece battery 811. The heater or heater component 843 is contained with the body portion 812. In such an example, the heater 843 is arranged in a cavity 845 or chamber in the body portion 812. The cavity 845 is accessed by an opening 845A in the body portion 812. The cavity 845 is arranged to receive an associated aerosol generating substrate or consumable 812.

The aerosol generating substrate 812 can contain an aerosol generating material, such as a tobacco rod containing tobacco. A tobacco rod can be similar to a traditional cigarette. The cavity 845 can have a cross-section approximately equal to that of the aerosol generating substrate 812. The cavity 845 can have a depth such that when the associated aerosol generating substrate 812 is inserted into the cavity 845, a first end portion 812A of the aerosol generating substrate 812 reaches a bottom portion 845B of the cavity 845 (that is, an end portion 845B of the cavity 845 distal from the cavity opening 845A), and a second end portion 812B of the aerosol generating substrate 812 distal to the first end portion 812A extends outwardly from the cavity 845. In this way, a consumer can inhale upon the aerosol generating substrate 812 when it is inserted into the aerosol generation device 100.

In the example of FIGS. 8A and 8B, the heater 847 is arranged in the cavity 845 such that the aerosol generating substrate 812 engages the heater 847 when inserted into the cavity 845. In the example of FIGS. 8A and 8B, the heater 847 is arranged as a tube in the cavity such that when the first end portion 812A of the aerosol generating substrate is inserted into the cavity the heater 847 substantially or completely surrounds the portion of the aerosol generating substrate 812 within the cavity 845. The heater 847 can be a wire, such as a coiled wire heater, or a ceramic heater, or any other suitable type of heater. The heater 847 can comprise multiple heating elements sequentially arranged along the axial length of the cavity that can be independently activated (i.e. powered up) in a sequential order.

In an alternative embodiment (not shown), the heater can be arranged as an elongate piercing member (such as in the form of needle, rod or blade) within the cavity; in such an embodiment the heater can be arranged to penetrate the aerosol generating substrate and engage the aerosol generating material when the aerosol generating substrate is inserted into the cavity.

In another alternative embodiment (not shown), the heater may be in the form of an induction heater. In such an embodiment, a heating element (i.e., a susceptor) can be provided in the substrate, and the heating element is inductively coupled to the induction element (i.e., induction coil) in the cavity when the substrate is inserted into the cavity. The induction heater then heats the heating element by induction.

The heater 847 is arranged to heat the tobacco, without burning the tobacco, to generate an aerosol. That is, the heater 847 heats the tobacco at a predetermined temperature below the combustion point of the tobacco such that a tobacco-based aerosol is generated. The skilled person will readily understand that the aerosol generating substrate 812 does not necessarily need to comprise tobacco, and that any other suitable substance for aerosolisation (or vaporisation), particularly by heating without burning the substance, can be used in place of tobacco.

In an alternative, the aerosol generating substrate can be a vaporisable liquid. The vaporisable liquid can be contained in a cartridge receivable in the aerosol generation device, or can be directly deposited into the aerosol generation device.

The charging unit 850 is dimensioned to receive and accommodate the handpiece 810 within an opening 890 in the charging unit 50. The charging unit battery 851 connects by connectors 880B in the charging unit opening 890 to corresponding connectors 880A in the handpiece 10 when the handpiece 810 is received in the charging unit 850. A controller in the handpiece 810 or the charging unit 850 can detect a signal between the handpiece connectors 880A and the charging unit connectors 880B and control a power flow from the charging unit battery 851 to the handpiece battery 811.

When received in the charging unit 850, the handpiece 810 can be arranged such that the cavity 845 is accessible from the opening 890 in the charging unit 850. In this way, an aerosol generating substrate 812 can be inserted into the cavity 845 when the handpiece 810 is connected to (or received in) the charging unit. Moreover, the consumer can then perform an aerosolisation session when the handpiece 810 is connected to (or received in) the charging unit by inhaling upon the accessible end 812B of the substrate 812 that extends from the handpiece 810 and charging unit 850.

As already described, the second exemplary aerosol generation device 800 can perform the same operations for an aerosolisation session, particularly regarding the pre-heating phase and heating phase of an aerosolisation session, the charging unit battery charging the handpiece battery, and the operations described with reference to FIG. 7 as those described with reference to the first exemplary aerosol generation device. For brevity, these are not repeated again here.

In the preceding examples, the processing steps described herein carried out by the controller of the handpiece, or the controller of the charging unit, may be stored in a non-transitory computer-readable medium, or storage, associated with the respective controller. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that the preceding embodiments in the foregoing description are not limiting; features of each embodiment may be incorporated into the other embodiments as appropriate.

1. An aerosol generation device comprising a holding unit configured to receive and aerosolise an aerosol generating substrate, and a charging unit connectable to the holding unit;
the holding unit comprising a heater component configured to aerosolise the aerosol generating substrate, and a first charge storage module configured to power the heater component;
the charging unit comprising a second charge storage module configured to power the heater component when the charging unit is connected to the holding unit;
the aerosol generation device further comprising a controller configured to:
when the holding unit is not connected to the charging unit, pre-heat the heater component to a predetermined temperature for an aerosolisation session by directing a first power flow from the first charge storage module to the heater component in a first pre-heating manner; and
when the holding unit is connected to the charging unit, pre-heat the heater component to the predetermined temperature for an aerosolisation session by directing a second power flow from the second charge storage module to the heater component in a second pre-heating manner.

2. The aerosol generation device of claim 1, wherein the first pre-heating manner comprises directing the first power flow from the first charge storage module to the heater component for a first predetermined period of time; and
wherein the second pre-heating manner comprises directing the second power flow from the second charge storage module to the heater component for a second predetermined period of time.

3. The aerosol generation device of claim 2, wherein the first predetermined period of time is longer than the second predetermined period of time, and the first power flow is a lower power than second power flow.

4. The aerosol generation device of claim 1, wherein the controller is configured to:
when the holding unit is connected to the charging unit, direct a power flow from the second charge storage module to the heater component to maintain the predetermined temperature in a heating phase of the aerosolisation session after the heater component is pre-heated; and
when the holding unit is not connected to the charging unit, direct a power flow from the first charge storage module to the heater component to maintain the predetermined temperature in the heating phase of the aerosolisation session after the heater component is pre-heated.

5. The aerosol generation device of claim 1, wherein the controller is further configured to:
when the holding unit is connected to the charging unit, direct a power flow from the second charge storage module to the first charge storage module to charge the first charge storage module.

6. The aerosol generation device of claim 1, wherein the holding unit is configured to be received within the charging unit when connected to charging unit.

7. The aerosol generation device of claim 6, wherein the holding unit comprises a cavity into which the aerosol generating substrate is insertable for heating with the heater component to generate an aerosol, and wherein the cavity is accessible to receive the aerosol generating substrate when the holding unit is received within the charging unit.

8. The aerosol generation device of claim 1, wherein the second charge storage module has a greater charge storage capacity than the first charge storage module.

9. The aerosol generation device of claim 1, wherein the aerosol generation device is configured to perform a first aerosolisation session followed consecutively by a second aerosolisation session, with each aerosolisation session comprising a pre-heating phase in which the heater component is pre-heated to the predetermined temperature, and a heating phase in which the heater component is maintained at the pre-determined temperature after the heater component is pre-heated.

10. The aerosol generation device of claim 9, wherein:
the pre-heating phase of the first aerosolisation session and the pre-heating phase of the second aerosolisation session are both performed when the holding unit is connected to the charging unit, and the controller is configured to direct the second power flow from the second charge storage module to the heater component in the second pre-heating manner for the pre-heating phase of the first aerosolisation session and the pre-heating phase of the second aerosolisation session; and
the heating phase of the first aerosolisation session and the heating phase of the second aerosolisation session are both performed when the holding unit is not connected to the charging unit, and the controller is configured to direct a power flow from the first charge storage module to the heater component for the heating phase of the first aerosolisation session and the heating phase of the second aerosolisation session.

11. The aerosol generation device of claim 9, wherein:
the pre-heating phase of the first aerosolisation session and the pre-heating phase of the second aerosolisation session are both performed when the holding unit is connected to the charging unit, and the controller is configured to direct the second power flow from the second charge storage module to the heater component in the second pre-heating manner for the pre-heating phase of the first aerosolisation session and the pre-heating phase of the second aerosolisation session;
the heating phase of the first aerosolisation session is performed when the holding unit is not connected to the charging unit, and the controller is configured to direct a power flow from the first charge storage module to the heater component for the heating phase of the first aerosolisation session; and
the heating phase of the second aerosolisation session is performed when the holding unit is connected to the charging unit, and the controller is configured to direct a power flow from the second charge storage module to the heater component for the heating phase of the second aerosolisation session.

12. The aerosol generation device of claim 10, wherein:
the controller is configured to direct the second power flow and a power flow from the first charge storage module to the heater component for the pre-heating phase of the first aerosolisation session and the pre-heating phase of the second aerosolisation session.

13. An aerosol generation system comprising the aerosol generation device of claim 1 comprising an aerosol generating substrate received in the holding unit of the aerosol generation device.

14. A method of operating an aerosol generation device, the aerosol generation device comprising:
a holding unit configured to receive and aerosolise an aerosol generating substrate and a charging unit connectable to the holding unit, the holding unit comprising a heater component configured to aerosolise the aerosol generating substrate, and a first charge storage module configured to power the heater component, the charging unit comprising a second charge storage module configured to power the heater component when the charging unit is connected to the holding unit;
wherein the method comprises:
when the holding unit is not connected to the charging unit, pre-heating the heater component to a predetermined temperature for an aerosolisation session by directing a first power flow from the first charge storage module to the heater component in a first pre-heating manner; and
when the holding unit is connected to the charging unit, pre-heating the heater component to a predetermined temperature for an aerosolisation session by directing a second power flow from the second charge storage module to the heater component in a second pre-heating manner.

15. A non-transitory computer-readable medium storing instructions executable by one or more processors of an aerosol generation device, the aerosol generation device comprising:
a holding unit configured to receive and aerosolise an aerosol generating substrate and a charging unit that is connectable to the holding unit, the holding unit comprising a heater component configured to aerosolise the aerosol generating substrate, and a first charge storage module configured to power the heater component, the charging unit comprising a second charge storage module configured to power the heater component when the charging unit is connected to the holding unit,
wherein the instructions cause the one or more processors to perform steps comprising:
when the holding unit is not connected to the charging unit, pre-heating the heater component to a predetermined temperature for an aerosolisation session by directing a first power flow from the first charge storage module to the heater component in a first pre-heating manner, and
when the holding unit is connected to the charging unit, pre-heating the heater component to a predetermined temperature for an aerosolisation session by directing a second power flow from the second charge storage module to the heater component in a second pre-heating manner.
